(19) United States
(12) Patent Application Publication
(10) Pub. No.: US 2005/0139420 A1
(43) Pub. Date: Jun. 30, 2005

(54) Fire ladder with wireless deployment

(76) Inventors: Michael Thomas Spoltore, Valley Stream, NY (US); Robert J. Orlando, Nesconset, NY (US); Robert S. Adonailo, Rockville Centre, NY (US)

Correspondence Address: HONEYWELL INTERNATIONAL, INC.;LAW DEPARTMENT, 101COLUMBIA ROAD, MORRISTOWN, NJ, 07692, US

(21) Appl. No.: 10/750,088

(22) Filed: Dec. 31, 2003

(51) Int. Cl. A62B 1/20

(52) U.S. Cl. 182/49

(57) ABSTRACT

A system and method to facilitate escape from a building in an emergency which includes apparatus for monitoring at least a part of a building for a life threatening conditions selected from the group consisting of fire, seismological and terrorist threats. The system also includes a fire ladder having a compact position and a deployed position. The fire ladder in the deployed position extends generally vertically. The system further includes apparatus for mounting the fire ladder proximate to the lower edge of an associated window in the building and apparatus for releasably retaining the fire ladder in the compact position. In addition the system further includes apparatus for releasing the fire ladder that is responsive to the apparatus for monitoring. The rungs of the ladder may have projections dimensioned and configured to rest against the side of the associated building when the ladder is deployed along the side of the associated building.

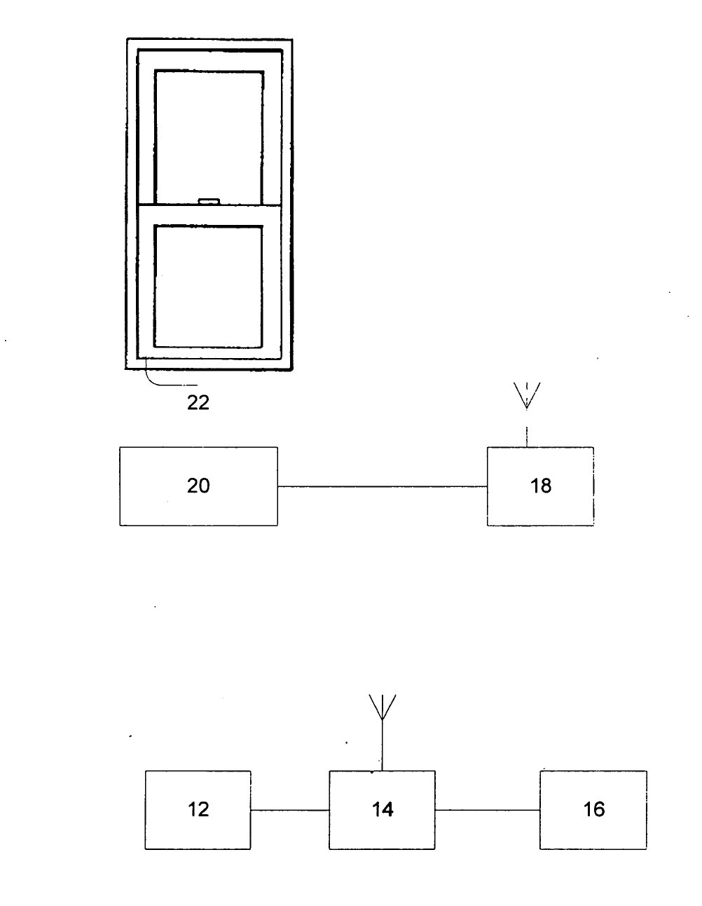

### BACKGROUND OF THE INVENTION

The invention relates to safety and security devices and methods and particularly to apparatus and methods for the emergency escape from the window of a building. One such emergency situation may occur during a fire. Similar situations may arise in the event of seismological or terrorist activity.

Security is a primary concern of homeowners. Due to the fact that people tend to place a high value on their property and personal safety, the marketplace has responded with a variety of products that are intended to protect life and property. One product that has seen wide use is the emergency escape ladder often used on two or three story homes and buildings. This chain ladder is unrolled or otherwise deployed from a window. Then the person climbs down to safety. While this process sounds easy, there are several steps involved with this process. In some known fire ladder constructions the ladder must be retrieved from its storage location. Second, it must be hooked to the window sill, hopefully in a secure fashion. Finally, the ladder must be unrolled, hopefully in an untangled manner.

The prior art includes a variety of ladders that can be deployed in such emergency situations. These include the devices shown in U.S. Pat. No. 6,382,352 issued on May 7, 2002 to Dowe, Sr.; U.S. Pat. No. 4,157,130 issued on Jun. 5, 1975 to Aberer; U.S. Pat. No. 4,164,991 issued on Aug. 21, 1979 to Marra; U.S. Pat. No. 4,189,028 issued on Feb. 19, 1980 to Reinhard; U.S. Pat. No. 4,31,046 issued on Apr. 26, 1983 to Landem; U.S. Pat. Nos. 4,434,871; and 4,531,612 issued on Jul. 30, 1985 to Sandor. The disclosures of these issued United States patents are hereby incorporated by reference.

The inventions described therein do provide additional safety of our buildings that do not have such ladders. However, they have not been wholly satisfactory. One concern is that a child or even a very distressed adult when confronted with smoke and danger may be traumatized and not deploy a conventional fire ladder. Particularly, in buildings where a number of occupants are trapped, panic is even more likely to complicate the manual deployment of a fire ladder. It must be remembered the required deployment steps are occurring under an emergency situation, where smoke, darkness, fear, unfamiliar surroundings and the like may be present.

### SUMMARY OF THE INVENTION

It is an object of the present invention to provide an additional measure of safety over known fire ladders.

More particularly, it is another object of the invention to provide a ladder that will automatically deploy upon the occurrence of a fire within the premises being protected.

Still another object of the invention is to provide apparatus that will respond to seismological and/or terrorist activity.

It has now been found that these and other objects of the invention may be attained in a system and method to facilitate escape from a building in an emergency which includes apparatus for monitoring at least a part of a building for a life threatening conditions selected from the group consisting of fire, seismological and terrorist threats. The system also includes a fire ladder having a compact position and a deployed position. The fire ladder in the deployed position extends generally vertically. The system further includes apparatus for mounting the fire ladder proximate to the lower edge of an associated window in the building and apparatus for releasably retaining the fire ladder in the compact position. In addition the system further includes apparatus for releasing the fire ladder that is responsive to the apparatus for monitoring.

In some forms the invention the apparatus includes photoelectric apparatus, ionization apparatus, fuzzy logic, Boolean logic, and/or one or more thermistors. The fire ladder may include a manual release for the ladder. The system may include a radiofrequency transmitter and a radiofrequency receiver.

The rungs of the ladder may have projections dimensioned and configured to rest against the side of the associated building when the ladder is deployed along the side of the associated building.

The objects of the present invention may also be achieved with the method to facilitate escape from a building in an emergency which includes monitoring at least a part of a building for a life threatening conditions selected from the group consisting of fire, seismological and terrorist threats, providing a fire ladder having a compact position and a deployed position, and which in the deployed position extends generally vertically and has rungs, mounting the fire ladder proximate to the lower edge of an associated window in a building and releasably retaining the fire ladder in the compact position, and releasing the fire ladder that is responsive to the monitoring step.

In some forms of the method in accordance with present invention, the monitoring step is performed with at least one of the complements selected from the list that includes: photoelectric apparatus, ionization apparatus, fuzzy logic, Boolean logic, a radiofrequency transmitter and at least one thermistor.

### BRIEF DESCRIPTION OF THE DRAWING

The invention will be better understood by reference the accompanying drawing illustrating schematically the window of a building and a fire ladder in combination with a wireless control system for deploying the ladder in the event of a fire. While the present invention has primary application for residential applications and emergencies such as fire, it will be understood that the invention also has application for other structures including commercial buildings and that the apparatus also has application to other emergency conditions including criminal invasions, terrorist acts and seismological events.

### DESCRIPTION OF THE PREFERRED EMBODIMENTS

Referring now to the figure, there is shown a system and method in accordance with one form of the present invention. The building on which the system is installed includes a smoke detector 12 that is connected to a radiofrequency transmitter 14. In the more sophisticated embodiments of the invention the system also includes a conventional security system 16 that includes a more sophisticated fire sensing apparatus and a control panel. The precise nature of this more sophisticated apparatus may vary without departing from the spirit of the present invention.

Examples of such more sophisticated fire sensing apparatus are shown in the following United States patents having the same assignee as the present application:
U.S. Pat. No. 6,150,935 One in and Fire Alarm System With Discrimination Between Smoke And Non-Smoke Phenomena issued on Nov. 21, 2000 to Anderson;
U.S. Pat. No. 6,084,522 Temperature Sensing Wireless Smoke Detector issued on Jul. 4, 2000 to Addy
U.S. Pat. No. 5,781,291 Smoke detectors utilizing a hydrophilic substance issued on Jul. 14, 1998 to So, et al.
U.S. Pat. No. 5,764,142 Fire alarm system with smoke particle discrimination issued on Jun. 9, 1998 to Anderson, et al.
U.S. Pat. No. 5,726,633 Apparatus and Method for Discrimination of Fire Types issued on Mar. 10, 1998 to Wiemeyer;
U.S. Pat. No. 5,659,292 Apparatus including a fire sensor and a non-fire sensor issued on Aug. 19, 1997 to Tice.
U.S. Pat. No. 5,633,501 Combination photoelectric and ionization smoke detector issued on May 27, 1997 to Amieshi, et al.
U.S. Pat. No. 5,557,262 Fire alarm system with different types of sensors and dynamic system parameters issued on Sep. 17, 1996 to Tice.
U.S. Pat. No. 5,117,219 Smoke and Fire Detection System Communication issued on May 26, 1992 to Tice, et al. one system to turn to move will
U.S. Pat. No. 4,916,432 Smoke and Fire Detection System Communication issued on May 26, 1992 to Tice, et al. one
U.S. Pat. No. 4,374,329 Smoke Detector with Test Apparatus issued on Feb. 15, 1983 to Schoenfelder, et al.
U.S. Pat. No. 4,316,184 Combination Combustion-Product Detector issued on Feb. 16, 1982 to Nagel.
U.S. Pat. No. 4,225,860 Sensitivity Controlled Dual Input Fire Detector issued on Sep. 30, 1980 to Conforti.
U.S. Pat. No. 4,097,851 Sensitivity Compensated Fire Detector issued on Jun. 27, 1978 to Klein.
U.S. Pat. No. 4,091,363 Self-contained Fire Detector with Interconnection Circuitry issued on May 23, 1978 to Siegel, et al.
U.S. Pat. No. 4,020,479 Fire Detector issued on Apr. 26, 1977 to Conforti, et al.

The disclosures of the above referred to patents are incorporated herein by reference. Various embodiments of the present invention may utilize different fire and smoke detecting means. In the simplest embodiment a conventional smoke detector will simultaneously produce an audible alarm and send a signal to the transmitter 14.

In some cases, the fire detection system includes apparatus for discrimination between various types of fires as described in U.S. Pat. No. 5,726,633 (referred to above). That apparatus relies on the characteristics of the smoke to determine the type of fire producing smoke. As noted therein flaming fires exhibit quite different smoke characteristics than smoldering fires. As also noted therein the different types of smoke sensors respond differently depending on the fire type. Thus, photoelectric detectors are known to respond more rapidly to smoldering fires than are ionization-type detectors. Similarly, ionization-type detectors are known to respond more rapidly to flaming type fires than do photo-electric detectors. The same patent describes fuzzy logic and Boolean logic techniques for analysis of such data. As described in U.S. Pat. No. 6,084,522 (referred to above) temperature sensing in combination with a smoke detector is also useful. For example various embodiments may include a photoelectric sensor for determining the presence of smoke and a plurality of thermistors for providing a temperature signal reflective of a temperature level.

A signal from the transceiver 14 is preferably a wireless radiofrequency signal that will be recognized by the receiver 18. Various embodiments may use other infrared other wireless data transfer means to transmit a signal to the receiver 18.

The receiver 18 is coupled to a fire ladder 20 disposed below a conventional window 22. The receiver 18 one receiving a signal from the transmitter 14 releases the fire ladder 20. The fire ladder 20 may be constructed in the general manner shown in the various United States patents listed in the Background of the Invention section of this application.

The fire ladder 10 will preferably include a manual release to permit deployment by the user in the event of any failure of the portion of the system that includes a fire and/or smoke detector. In addition the respective steps are preferably shaped so that individual steps include projections that extend toward the side of the building (on which the apparatus is mounted) a sufficient amount to stabilize (by physical contact) the ladder with respect to the side of the building. A ladder construction having nesting rigid generally U-shaped rungs as shown in U.S. Pat. No. 4,434,871 lends itself to projections that extend horizontally from each rung. It will be understood that the ladder may be collapsed after use and stowed ready for deployment again at some future time.

The invention also includes the method to facilitate escape from a building in an emergency which includes monitoring at least a part of a building for a life threatening conditions selected from the group consisting of fire, seismological and terrorist threats, providing a fire ladder having a compact position and a deployed position, and which in the deployed position extends generally vertically and has rungs, mounting the fire ladder proximate to the lower edge of an associated window in a building and releasably retaining the fire ladder in the compact position; and releasing the fire ladder that is responsive to the monitoring step.

In some forms of the method in accordance with present invention the monitoring step is performed with features selected from the group selected from the group photoelectric apparatus, ionization apparatus, fuzzy logic, Boolean logic, a thermistor, and a radiofrequency transmitter. The providing step may include providing a manual release for the ladder.

The method may also be with a performing step that includes providing rungs of the ladder that have projections dimensioned and configured to rest against the side of and associated building when the ladder is deployed along the side of the associated building.

Although the description herein has emphasized fire responder personnel those skilled in the art will recognize that the apparatus in accordance with the present invention has application to other emergency situations. For example, other forms in the invention may include seismological monitoring equipment either in combination with the above described apparatus or as a substitute for the fire detection apparatus. The seismological monitoring equipment may include conventional sensing devices known in the art. The prior art includes various automobile and building alarms that rely on impact and/or concussion to initiate an alarm. While the sensitivity of such systems is not directly applicable for use with fire ladders, those skilled in the art will recognize that the general type of sensors employed therein may be utilized to initiate deployment of a so-called “fire ladder” in the event of earthquakes as well as acts of war or terrorism. For purposes of this application “seismological monitoring equipment” will be understood to include equipment that can detect major acts of war as well as terrorism in addition to earthquakes and related phenomenon and “seismological events” includes earthquakes and earthquake related phenomenon as well as major acts of warfare and terrorism.

The respective methods and systems in accordance with the present system may utilize a computer that includes a microprocessor and memory and which cooperates with software that is commercially available or within the skill of practitioners in the programming arts.

The term “fire ladder” has been used herein. Such apparatus also has application to other life threatening situations in addition to the threat from fire.

The use of the present invention provides a means of safe egress from the upper floors of a building in the event of a fire or other emergency that can be quickly deployed in a manner which is safe, quick and effective.

It will be obvious to those having skill in the art that many changes may be made to the details of the above-described embodiments of this invention without departing from the underlying principles thereof. Accordingly, it will be appreciated that this invention is also applicable to other systems. The scope of this invention should, therefore, be looking reasonable boom in and out a determined only by the following claims.

1. A system to facilitate escape from a building in an emergency which comprises:
means for monitoring at least a part of a building for a life threatening conditions selected from the group consisting of fire, seismological and terrorist threats;
a fire ladder having a compact position and a deployed position, the fire ladder in the deployed position extending generally vertically, said fire ladder having rungs;
means for mounting the fire ladder proximate to the lower edge of an associated window in the building and means for releasably retaining the fire ladder in the compact position; and
means for releasing said fire ladder that is responsive to said means for monitoring.

2. The system as described in claim 1 wherein the means for monitoring includes photoelectric apparatus.

3. The system as described in claim 1 wherein the means for monitoring includes ionization apparatus.

4. The system as described in claim 1 wherein the system utilizes fuzzy logic.

5. The system as described in claim 1 wherein the system utilizing Boolean logic.

6. The system as described in claim 1 wherein the system utilizes a thermistor.

7. The system as described in claim 1 wherein the system utilizes a plurality of thermistors.

8. The system as described in claim 1 wherein the system includes a manual release for the ladder.

9. The system as described in claim 1 wherein the system includes a radiofrequency transmitter.

10. The system as described in claim 1 wherein the system includes a radiofrequency receiver.

11. The system as described in claim 1 wherein the rungs of the ladder have projections dimensioned and configured to rest against the side of the associated building when the ladder is deployed along the side of the associated building.

12. The system as described in claim 2 wherein the rungs of the ladder have projections dimensioned and configured to rest against the side of the associated building when the ladder is deployed along the side of the associated building.

13. The system as described in claim 3 wherein the rungs of the ladder have projections dimensioned and configured to rest against the side of the associated building when the ladder is deployed along the side of the associated building.

14. The system as described in claim 4 wherein the rungs of the ladder have projections dimensioned and configured to rest against the side of the associated building when the ladder is deployed along the side of the associated building.

15. The system as described in claim 5 wherein the rungs of the ladder have projections dimensioned and configured to rest against the side of the associated building when the ladder is deployed along the side of the associated building.

16. The system as described in claim 6 wherein the rungs of the ladder have projections dimensioned and configured to rest against the side of the associated building when the ladder is deployed along the side of the associated building.

17. The system as described in claim 7 wherein the rungs of the ladder have projections dimensioned and configured to rest against the side of the associated building when the ladder is deployed along the side of the associated building.

18. The system as described in claim 8 wherein the rungs of the ladder have projections dimensioned and configured to rest against the side of the associated building when the ladder is deployed along the side of the associated building.

19. The system as described in claim 9 wherein the rungs of the ladder have projections dimensioned and configured to rest against the side of the associated building when the ladder is deployed along the side of the associated building.

20. The system as described in claim 10 wherein the rungs of the ladder have projections dimensioned and configured to rest against the side of the associated building when the ladder is deployed along the side of the associated building.

21. A system to facilitate escape from a building in an emergency which comprises:
means for monitoring at least a part of a building for a life threatening conditions selected from the group consisting of apparatus that employs parts thereof selected from the group consisting of photoelectric apparatus, ionization apparatus, fuzzy logic, Boolean logic, and at least one thermistor;
a fire ladder having a compact position and a deployed position, the fire ladder in the deployed position extending generally vertically, said fire ladder having rungs;
means for mounting the fire ladder proximate to the lower edge of an associated window in the building and means for releasably retaining the fire ladder in the compact position; and
means for releasing said fire ladder that is responsive to said means for monitoring.

22. The system as described in claim 21 wherein the rungs of the ladder have projections dimensioned and configured to rest against the side of the associated building when the ladder is deployed along the side of the associated building.

23. A system to facilitate escape from a building in an emergency which comprises:
means for monitoring at least a part of a building for a life threatening conditions selected from the group consisting of apparatus that employs parts thereof selected from the group consisting of photoelectric apparatus, ionization apparatus, fuzzy logic, Boolean logic, and at least one thermistor;
a fire ladder having a compact position and a deployed position, the fire ladder in the deployed position extending generally vertically, said fire ladder having rungs having projections dimensioned and configured to rest against the side of the associated building when the ladder is deployed along the side of the associated building
means for mounting the fire ladder proximate to the lower edge of an associated window in the building and means for releasably retaining the fire ladder in the compact position; and
means for releasing said fire ladder that is responsive to said means for monitoring.

24. A method to facilitate escape from a building in an emergency which comprises:
monitoring at least a part of a building for a life threatening conditions selected from the group consisting of fire, seismological and terrorist threats;
providing a fire ladder having a compact position and a deployed position, and which in the deployed position extends generally vertically and has rungs;
mounting the fire ladder proximate to the lower edge of an associated window in a building and releasably retaining the fire ladder in the compact position; and
releasing the fire ladder that is responsive to the monitoring step.

25. The method as described in claim 24 wherein the monitoring step is performed with photoelectric apparatus.

26. The method as described in claim 24 wherein the monitoring step is performed with ionization apparatus.

27. The method as described in claim 24 wherein the monitoring step is performed in a manner that utilizes fuzzy logic.

28. The method as described in claim 24 wherein the monitoring step is performed in a manner that utilizes Boolean logic.

29. The method as described in claim 24 wherein the monitoring step is performed in a manner that utilizes a thermistor.

30. The method as described in claim 24 wherein the monitoring step is performed in a manner that utilizes a plurality of thermistors.

31. The method as described in claim 24 wherein the method includes providing a manual release for the ladder.

32. The method as described in claim 24 wherein the method includes providing a radiofrequency transmitter.

33. The method as described in claim 24 wherein the method includes providing a radiofrequency receiver.

34. The method as described in claim 24 wherein the method includes providing rungs of the ladder that have projections dimensioned and configured to rest against the side of the associated building when the ladder is deployed along the side of the associated building.

35. The method as described in claim 24 wherein the method includes providing rungs of the ladder that have projections dimensioned and configured to rest against the side of the associated building when the ladder is deployed along the side of the associated building.

36. The method as described in claim 24 wherein the rungs of the ladder have projections dimensioned and configured to rest against the side of the associated building when the ladder is deployed along the side of the associated building.

37. The method as described in claim 24 wherein the rungs of the ladder have projections dimensioned and configured to rest against the side of the associated building when the ladder is deployed along the side of the associated building.
